(19) United States
(12) Patent Application Publication
(10) Pub. No.: US 2010/0317208 A1
(43) Pub. Date: Dec. 16, 2010

(54) SAFETY DOOR FOR A ROTATABLE POWER SUPPLY SOCKET

(75) Inventors: Fu Hua Chen, Qiligang Town (CN); Lidong Ni, Huanghua Town (CN); Chongguang Zhang, Liushi Town (CN)

Correspondence Address: ZIEGLER IP LAW GROUP, LLC., 518 RIVERSIDE AVENUE, BUILDING B (Synergy), WESTPORT, CT, 06880, US

(73) Assignee: WENZHOU MTLC ELECTRIC APPLIANCE CO., LTD., Leqing (US)

(21) Appl. No.: 12/699,796

(22) Filed: Feb. 3, 2010

(30) Foreign Application Priority Data
Feb. 24, 2009 (CN) 200910009201.7

(51) Int. Cl. H01R 13/44

(52) U.S. Cl. 439/140

(57) ABSTRACT

A safety door for a rotatable power supply socketincludes a mounting base with composite plugging holes, first, second and third sliding parts, and an elastic assembly. The composite plugging holes include a left-hand, middle and right-hand plugging hole, and an upper and lower ground plugging hole. While sliding in a rail slot of the mounting base, the first sliding part can block the left-hand plugging hole while sliding along the left-right direction, the second sliding part can block the right-hand plugging hole while sliding along the left-right direction; the third sliding part can block or expose the middle plugging hole while sliding along the left-right direction. The elastic assembly includes a first elastic part for providing returning elastic force to the first sliding part and a second elastic part for providing returning elastic force to the second sliding part.

### BACKGROUND

1. Field

The aspects of the disclosed embodiments belong to the technical field of electric connectors and, particularly, relate to a safety door for a rotatable power supply socket.

2. Brief Description of Related Developments

At present, there is a type of three-hole power supply socket which is mounted on the wall, and comprises two rectangular plugging holes arranged in parallel with one another and a semicircular ground plugging hole, with the three plugging holes arranged in a triangle arrangement; once this power supply socket is mounted on the wall, the arrangement of the three plugging holes are fixed along with it, for example, with two rectangular plugging holes at the lower part and the ground plugging hole at the upper part; and due to the reasons for ensuring the circuit security, the three-hole plugs for fitting therein generally use cables of relatively large diameters, which are not easy to bend or with a very small bendable degree, leading to a preferred orientation for the use of such plugs, such that the plugs can be plugged conveniently in the defined direction of the metal plug pieces, while the plugging is inconvenient if the plug is plugged in the reversed direction. For example, most computer power lines are of large diameters and limited lengths, and it happens often that the length of a line is not enough or the three-plug arrangement is not consistent with the three-plugging hole arrangement, leading to inconvenience in its use.

### SUMMARY

The disclosed embodiments provide a safety door for a rotatable power supply socket, into which a three-hole plug is allowed to be inserted either in a certain orientation or in an orientation rotated by 180 degrees.

The technical solution for achieving the object of the disclosed embodiments is as follows: a safety door for a rotatable power supply socket, comprising a mounting base provided with composite plugging holes; a first sliding part, a second sliding part and a third sliding part which are in mutual cooperation; and an elastic assembly provided on the mounting base; wherein said composite plugging holes comprise three rectangular plugging holes arranged at equal distance and in parallel with one another and two ground plugging holes acting as the ground lines, and said two ground plugging holes are located respectively at the upper side and the lower side of the rectangular plugging holes; the three rectangular plugging holes from left-hand to right are referred to as the left-hand plugging hole, the middle plugging hole and the right-hand plugging hole; the two ground plugging holes from top downwards are referred to as the upper grounded plugging hole and lower grounded plugging hole; said left-hand plugging hole, middle plugging hole and upper ground plugging hole constitute a first three-hole power supply socket; and said middle plugging hole, right-hand plugging hole and lower ground plugging hole constitute a second three-hole power supply socket;

said mounting base is provided with a rail slot for disposing said first sliding part, second sliding part and said third sliding part;

said first sliding part can slide reciprocally in said rail slot in the left-right direction, and the first sliding part can block or expose the left-hand plugging hole during its sliding movements;

said second sliding part can slide reciprocally in said rail slot in the left-right direction, and said second sliding part can block or expose the right-hand plugging hole during its sliding movements;

said third sliding part can slide reciprocally in the rail slot in the left-right direction, and said third sliding part can block or expose the middle plugging hole during its sliding movements;

said elastic assembly comprises two main elastic parts for providing returning elastic forces to the third sliding part, a first elastic part for providing a returning elastic force to the first sliding part and a second elastic part for providing a returning elastic force to the second sliding part; and wherein said two main elastic parts are located respectively at two sides of the third sliding part.

In the above technical solution, the left-hand end of said first sliding part is provided with a block part for blocking the left-hand plugging hole, the right-hand end is provided with a bearing part for bearing external forces; the bottom part of said bearing part is provided with a sliding groove; a limiting hole is provided between said block part and said bearing part; the right-hand end of said bearing part is provided with a slope surface or an arc face acting as the bearing surface; when unloaded, said bearing part is located just above said middle plugging hole and blocks the lower half of said middle plugging hole, and said block part is located just above said left-hand plugging hole and wholly blocks the left-hand plugging hole;

the left-hand end of said second sliding part is provided with a bearing part for bearing external forces, the right-hand end is provided with a block part for blocking the right-hand plugging hole; the bottom part of said bearing part is provided with a sliding groove; a limiting hole is provided between said block part and said bearing part; the left-hand end of said bearing part is provided with a slope surface or an arc face acting as the bearing surface; when unloaded, said bearing part is located just above said middle plugging hole and blocks the upper half of said middle plugging hole, and said block part is located just above said right-hand plugging hole and blocks the whole right-hand plugging hole;

the left-hand end of said third sliding part is provided with a left-hand bearing part for bearing external forces, the right-hand end thereof is provided with a right-hand bearing part for bearing external forces, the middle end is provided with a block part for blocking the middle plugging hole; between said left-hand bearing part and said block part and also between said right-hand bearing part and said block part are each arranged with a limiting hole; the left-hand end of said left-hand bearing part is provided with a slope surface or an arc face acting as the bearing surface, and the right-hand end of said right-hand bearing part is provided with a slope surface or an arc face acting as the bearing surface; and when unloaded, said block part is located just above said middle plugging hole and in the sliding groove at the bottom part of the bearing part of said first sliding part and the bearing part of said second sliding part, blocking the whole middle plugging hole.

In the above technical solution, said two main elastic parts are respectively left-hand main elastic part and right-hand main elastic part; wherein the left-hand main elastic part is arranged at the left-hand side of the third sliding part, with one end thereof abutting against the mounting base while the other end abuts against the left-hand end of the third sliding part; the right-hand main elastic part is arranged at the right-hand side of the third sliding part, with one end thereof abutting against the mounting base while the other end abuts against the right-hand end of the third sliding part; said first sliding part is located at the left-hand side of the first sliding part, with one end thereof abutting against the mounting base while the other end abuts against the left-hand end of the first sliding part; and said second sliding part is located at the right-hand side of the second sliding part, with one end thereof abutting against the mounting base while the other end abuts against the right-hand end of the second sliding part.

In the above technical solution, said two main elastic parts, the first elastic part and the second elastic part are all leaf springs; and said mounting base is provided with a positioning stud assembly for fixing the leaf springs.

In the above technical solution, the mounting base is provided with a left-hand limiting part for limiting the sliding distance of the first sliding part and a right-hand limiting part for limiting the sliding distance of the second sliding part; said left-hand limiting part is a boss projecting upwards from the right-hand margin of the left-hand plugging hole and is located in the limiting hole of said first sliding part; said right-hand limiting part is a boss projecting upwards from the left-hand margin of the right-hand plugging hole and is located in the limiting hole of said second sliding part.

In the above technical solution, the left-hand plugging hole can be exposed while said first sliding part is sliding towards the left; and the left-hand plugging hole is blocked when said first sliding part returns to its original position;

said second sliding part can slide reciprocally in the rail slot along the left-right direction, the right-hand plugging hole can be exposed while the second sliding part is sliding towards the right; and the right-hand plugging hole is blocked when said second sliding part returns to its original position;

said third sliding part can slide reciprocally in the rail slot along the left-right direction, the middle plugging hole can be exposed while said third sliding part is sliding either towards the left-hand or towards the right; and the middle plugging hole is blocked when said third sliding part returns to its original position.

In the above technical solution, said first sliding part and said second sliding part are identical both in structure and in size.

In the above technical solution, the basic shape of the ground plugging holes is a semicircle

The disclosed embodiments have the following positive effects:
(1) By providing the composite plugging holes and a safety door made of three mutually cooperating sliding parts and corresponding elastic parts for blocking the three rectangular plugging holes (i.e. the plugging holes for the electric connection) in the composite plugging holes, an external three-hole plug can either be plugged into the first electric socket of the composite plugging holes, or be plugged into the second electric socket after having been rotated by 180 degrees.
(2) The unique structural design ensures that when a hard object, such as a nail, is plugged into a single rectangular plugging hole, the object will not be able to make contact with the power line through a plugging hole, therefore no electric shock will happen, so the safety of children is effectively guaranteed; and electric contact with the power lines can only be made if the left-hand plugging hole and the middle plugging hole are plugged into simultaneously, or the right-hand plugging hole and the middle plugging hole are plugged into simultaneously.

(3) The first sliding part and second sliding part are identical both in structure and in size, and are made from the same mold, thus reducing the production costs.

### BRIEF DESCRIPTION OF THE DRAWINGS

FIG. 1 is a perspective structural diagram;

FIG. 2 is a schematic structural diagram observed in a front view of the safety door for a rotatable power supply socket as shown in FIG. 1;

FIG. 3 is an exploded structural diagram of the safety door for a rotatable power supply socket as shown in FIG. 1;

FIG. 4 is a perspective structural diagram of the third sliding part of the safety door for a rotatable power supply socket as shown in FIG. 1;

FIG. 5 is a perspective structural diagram of the third sliding part as shown in FIG. 4 in another angle of view;

FIG. 6 is a perspective structural diagram of the second sliding part of the safety door for a rotatable power supply socket as shown in FIG. 4;

FIG. 7 is a perspective structural diagram of the second sliding part as shown in FIG. 6 in another angle of view;

FIG. 8 is a perspective structural diagram of the second sliding part as shown in FIG. 7 in another angle of view;

FIG. 9 is a structural diagram of the second sliding part as shown in FIG. 7 in a front view;

FIG. 10 is a structural diagram of the first sliding part combined with the second sliding part of the safety door for a rotatable power supply socket as shown in FIG. 1;

FIG. 11 is a structural diagram of FIG. 10 in direction A.

### DETAILED DESCRIPTION OF THE DISCLOSED EMBODIMENTS

The symbols shown in the drawings are: composite plugging holes 1, rectangular plugging holes 11, a left-hand plugging hole 111, a middle plugging hole 112, a right-hand plugging hole 113, ground plugging holes 12, an upper ground plugging hole 121, a lower ground plugging hole 122, a mounting base 2, a rail slot 21, a positioning stud assembly 22, a left-hand limiting part 23, a right-hand limiting part 24, a first sliding part 3, a blocking part 31, a bearing part 32, a bearing surface 321, a sliding groove 33, a limiting hole 34, a second sliding part 4, a bearing part 41, a bearing surface 411, a block part 42, a sliding groove 43, a limiting hole 44, a third sliding part 5, a left-hand bearing part 51, a bearing surface 511, a right-hand bearing part 52, a block part 53, a limiting hole 54, an elastic assembly 6, a main elastic part 61, a left-hand main elastic part 611, a right-hand main elastic part 612, a first elastic part 62, a second elastic part 63, a first power supply socket 100 and a second power supply socket 200.

### Embodiment 1

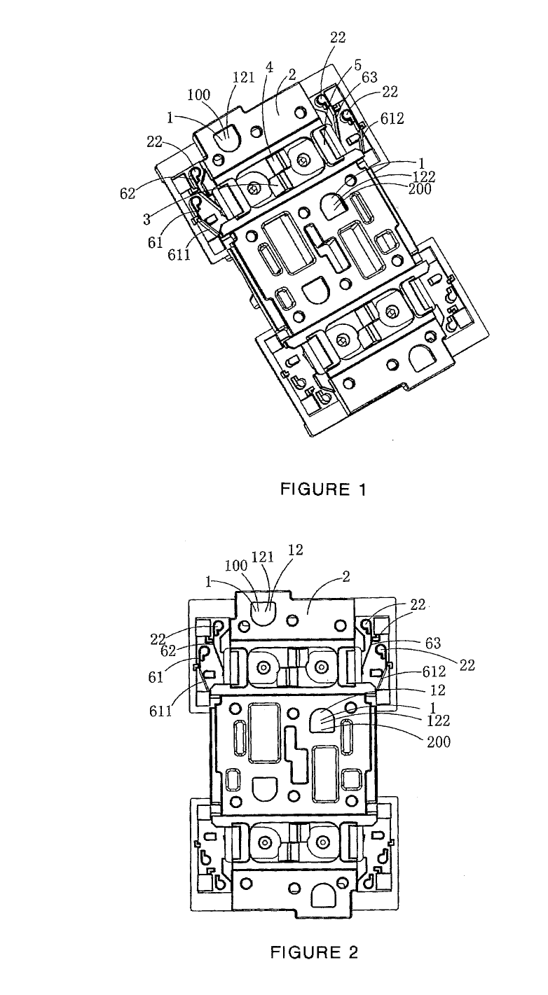

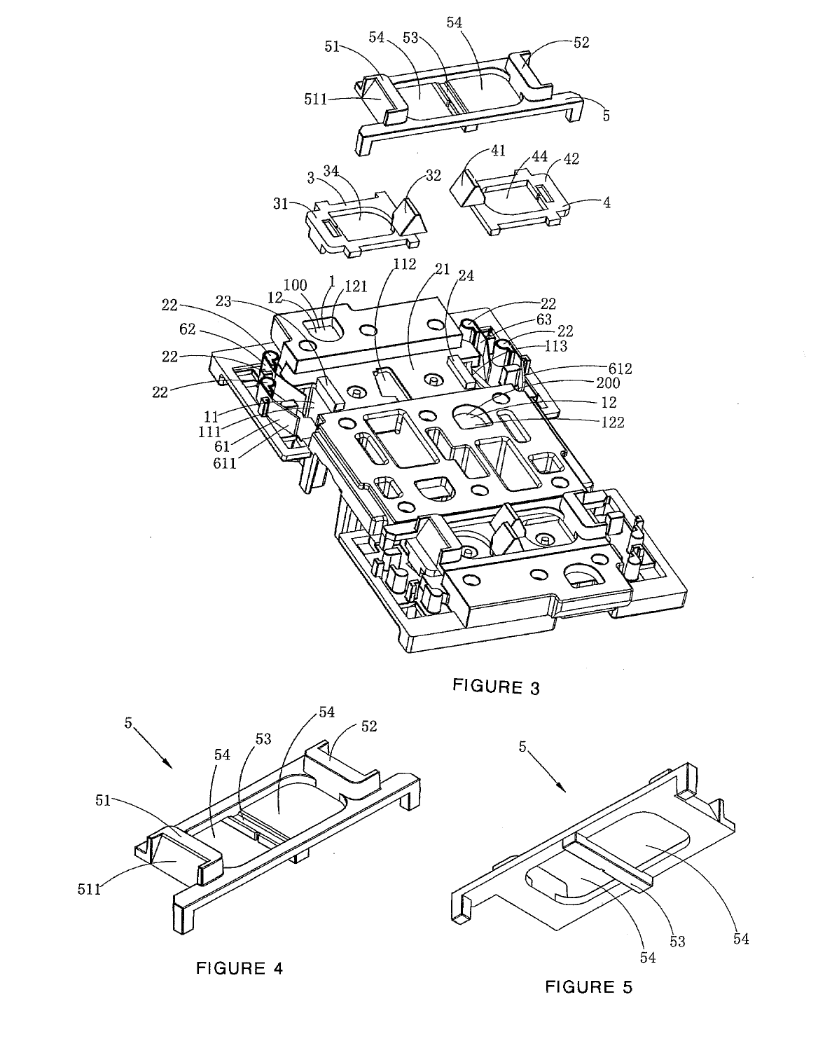

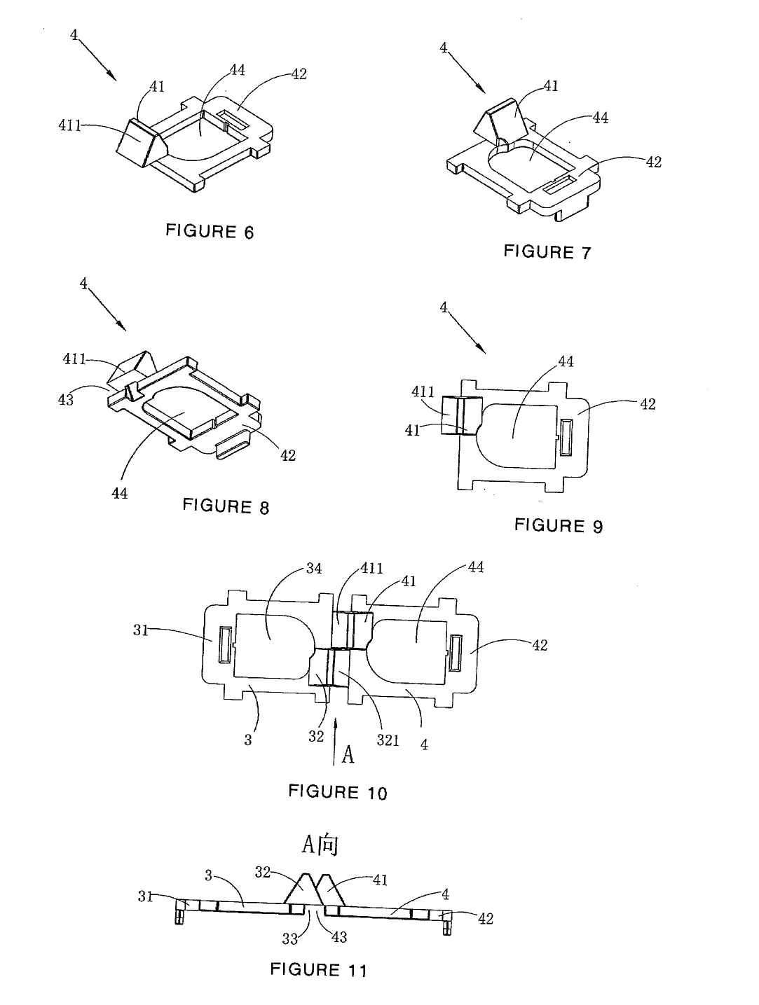

FIG. 1 to FIG. 11 illustrate a first embodiment, wherein FIG. 1 is a perspective structural diagram of the disclosed embodiments; FIG. 2 is a front view structural diagram of the safety door for a rotatable power supply socket as shown in FIG. 1; FIG. 3 is an exploded structural diagram of the safety door for a rotatable power supply socket as shown in FIG. 1; FIG. 4 is a perspective structural diagram of the third sliding part of the safety door for a rotatable power supply socket as shown in FIG. 1; FIG. 5 is a perspective structural diagram of the third sliding part as shown in FIG. 4 in another angle of view; FIG. 6 is a perspective structural diagram of the second sliding part of the safety door for a rotatable power supply socket as shown in FIG. 4; FIG. 7 is a perspective structural diagram of the second sliding part as shown in FIG. 6 in another angle of view; FIG. 8 is a perspective structural diagram of the second sliding part as shown in FIG. 7 in another angle of view; FIG. 9 is a structural diagram of the second sliding part as shown in FIG. 7 in a front view; FIG. 10 is a structural diagram of the first sliding part combined with the second sliding part of the safety door for a rotatable power supply socket as shown in FIG. 1; and FIG. 11 is a structural diagram of FIG. 10 in direction A.

This embodiment is a safety door for a rotatable power supply socket and, as shown in FIG. 3, it comprises a mounting base 2 provided with composite plugging holes 1, a first sliding part 3, a second sliding part 4 and a third sliding part 5 which are in mutual cooperation, and an elastic assembly 6 provided on the mounting base 2;

Referring to FIG. 1 to FIG. 3, said composite plugging holes 1 comprise three rectangular plugging holes 11 arranged at equal distance and in parallel with one another and two ground plugging holes 12 acting as the grounding lines, and said two ground plugging holes 12 are located respectively at the upper side and the lower side of the rectangular plugging holes 11; the three rectangular plugging holes 11 from left to right are referred to in sequence as the left-hand plugging hole 111, the middle plugging hole 112 and the right-hand plugging hole 113; said two ground plugging holes 12 from top downwards are referred to in sequence as the upper grounded plugging hole 121 and the lower grounded plugging hole 122; said left-hand plugging hole 111, middle plugging hole 112 and upper ground plugging hole 121 constitute a first three-hole power supply socket 100; said middle plugging hole 112, the right-hand plugging hole 113 and the lower ground plugging hole 122 constitute a second three-hole power supply socket 200; and the basic shape of said ground plugging holes 12 is semicircular.

Referring to FIG. 3, said mounting base 2 is provided with a rail slot 21 for disposing therein said first sliding part 3, second sliding part 4 and third sliding part 5; said first sliding part 3 can slide reciprocally in the rail slot 21 along the left-right direction, and said first sliding part 3 can block or expose the left-hand plugging hole 111 during its sliding movements; said second sliding part 4 can slide reciprocally in the rail slot 21 along the left-right direction, and said second sliding part 4 can block or expose the right-hand plugging hole 113 during its sliding movements; said third sliding part 5 can slide reciprocally in the rail slot 21 along the left-right direction, and said third sliding part 5 can block or expose the middle plugging hole 112 during its sliding movements;

Referring to FIG. 1 to FIG. 3, the elastic assembly 6 comprises two main elastic parts 61 for providing returning forces to the third sliding part 5, a first elastic part 62 for providing a returning force to the first sliding part 3 and a second elastic part 63 for providing a returning force to the second sliding part 4; and said two main elastic parts 61 are located at two sides of the third sliding part 5.

Referring to FIG. 6 to FIG. 11, said first sliding part 3 and second sliding part 4 in the embodiment are identical both in structure and in size.

Referring to FIG. 3 and FIG. 10, the left-hand end of said first sliding part 3 is provided with a block part 31 for blocking the left-hand plugging hole 111, the right-hand end is provided with a bearing part 32 for bearing external forces; the bottom part of said bearing part 32 is provided with a sliding groove 33; a limiting hole 34 is provided between said block part 31 and said bearing part 32; the right-hand end of said bearing part 32 is provided with a slope surface or an arc face acting as the bearing surface 321; when unloaded, the bearing part 32 is located just above said middle plugging hole 112 and blocks the lower half of said middle plugging hole 112, and said block part 31 is located just above said left-hand plugging hole 111 and blocks the whole left-hand plugging hole 111;

Referring to FIG. 6 to FIG. 11, the left-hand end of said second sliding part 4 is provided with a bearing part 41 for bearing external forces, the right-hand end is provided with a block part 42 for blocking the right-hand plugging hole 113; the bottom part of said bearing part 41 is provided with a sliding groove 43; a limiting hole 44 is provided between said block part 42 and said bearing part 41; the left-hand end of said bearing part 41 is provided with a slope surface or an arc face acting as the bearing surface 411; when unloaded, said bearing part 41 is located just above said middle plugging hole 112 and blocks the upper half of said middle plugging hole 112, and said block part 42 is located just above said right-hand plugging hole 113 and blocks the whole right-hand plugging hole 113;

Referring to FIG. 3 to FIG. 5, the left-hand end of the said third sliding part 5 is provided with a left-hand bearing part 51 for bearing external forces, the right-hand end is provided with a right-hand bearing part 52 for bearing external forces, the middle end is provided with a block part 53 for blocking the middle plugging hole 112; between said left-hand bearing part 51 and said block part 53 and also between said right-hand bearing part 52 and said block part 53 are each provided with a limiting hole 54; the left-hand end of said left-hand bearing part 51 is provided with a slope surface or an arc face acting as the bearing surface 511, and the right-hand end of said right-hand bearing part 52 is provided with a slope surface or an arc face acting as the bearing surface; and when unloaded, said block part 53 is located just above said middle plugging hole 112 and in the sliding groove at the bottom part of the bearing part 32 of said first sliding part 3 and the bearing part 41 of said second sliding part 4, blocking the whole middle plugging hole 112.

Referring to FIG. 1 to FIG. 3, said two main elastic parts 61 are respectively a left-hand main elastic part 611 and a right-hand main elastic part 612; the left-hand main elastic part 611 is arranged at the left-hand side of the third sliding part 5, with one end thereof abutting against the mounting base 2 while the other end abuts against the left-hand end of the third sliding part 5; the right-hand main elastic part 612 is arranged at the right-hand side of the third sliding part 5, with one end thereof abutting against the mounting base 2 while the other end abuts against the right-hand end of the third sliding part 5;

said first sliding part 3 is arranged at the left-hand side of the first sliding part 3, with one end thereof abutting against the mounting base 2 while the other end abuts against the left-hand end of the first sliding part 3; and said second sliding part 4 is arranged at the right-hand side of the second sliding part 4, with one end thereof abutting against the mounting base 2 while the other end abuts against the right-hand end of the second sliding part 4.

Referring to FIG. 3, said mounting base 2 is provided with a left-hand limiting part 23 for limiting the sliding distance of the first sliding part 3 and a right-hand limiting part 24 for limiting the sliding distance of the second sliding part 4; said left-hand limiting part 23 is a boss projecting upwards from the right-hand margin of the left-hand plugging hole 111 and is located in the limiting hole 34 of said first sliding part 3; said right-hand limiting part 24 is a boss projecting upwards from the left-hand margin of the right-hand plugging hole 113 and is located in the limiting hole 44 of said second sliding part 4.

In this embodiment, said two main elastic parts 61, the first elastic part 62 and the second elastic part 63 are all leaf springs; said mounting base 2 is provided with a positioning stud assembly 22 for fixing the leaf springs.

In this embodiment, the left-hand plugging hole 111 can be exposed while said first sliding part 3 is sliding towards the left; and the left-hand plugging hole 111 is blocked when said first sliding part 3 returns to its original position;

said second sliding part 4 can slide reciprocally in the rail slot 21 along the left-right direction, the right-hand plugging hole 113 can be exposed while said second sliding part 4 is sliding towards the right; and the right-hand plugging hole 113 is blocked when said second sliding part 4 returns to its original position;

said third sliding part 5 can slide reciprocally in the rail slot 21 along the left-right direction, the middle plugging hole 112 can be exposed while said third sliding part 5 is sliding either towards the left-hand or towards the right; and the middle plugging hole 112 is blocked when said third sliding part 5 returns to its original position.

In the practical use of this embodiment, when an external three-hole plug is simultaneously plugged into the left-hand plugging hole, the middle plugging hole and the upper ground plugging hole, a rectangular plugging piece of the three-hole plug corresponding to the left-hand plugging hole presses against the left-hand bearing surface of the third sliding part, so that the third sliding part slides rightwards and exposes the middle plugging hole; at the same time, another rectangular plugging piece of the three-hole plug corresponding to the middle plugging hole presses against the bearing surface of the first sliding part and the bearing surface of the second sliding part simultaneously, so that the first sliding part slides leftwards and the second sliding part slides rightwards, such that the block part of the first sliding part no longer blocks the left-hand plugging hole; by then, the three-hole plug can be smoothly plugged into the first power supply socket 100 of the mounting base according to the aspects of the disclosed embodiments;

Furthermore, if the three-hole plug is rotated by 180 degrees, it can be plugged into a second power supply socket 200 consisting of the right-hand plugging hole, the middle plugging hole and the lower ground plugging hole, a rectangular plugging piece of the three-hole plug corresponding to the right-hand plugging hole presses against the right-hand bearing surface of the third sliding part, so that the third sliding part slides leftwards and exposes the middle plugging hole; at the same time, a rectangular plugging piece of the three-hole plug corresponding to the middle plugging hole presses against the bearing surface of the first sliding part and the bearing surface of the second sliding part simultaneously, so that the first sliding part slides leftwards and the second sliding part slides rightwards, such that the block part of the second sliding part no longer blocks the right-hand plugging hole; at this time, the three-hole plug can be smoothly plugged into the second power supply socket hole 200 of the mounting base according to the aspects of the disclosed embodiments.

This embodiment has good safety properties, for example, if a single nail is plugged into any one of the left-hand plugging hole, the right-hand plugging hole and the middle plugging hole, although the nail presses against the bearing surface of a corresponding sliding part and drives this sliding part to slide, the sliding part blocking the plugging hole does not move, therefore the nail cannot get through the plugging hole and make contact with the power supply, therefore no electric shock will happen.

This embodiment has the following advantages:
(1) In this embodiment, by providing the composite plugging holes and a safety door made of three mutually cooperating sliding parts and corresponding elastic parts for blocking the three rectangular plugging holes (i.e. the plugging holes for the electric connection) in the composite plugging holes, an external three-hole plug can either be plugged into the first electric socket of the composite plugging holes, or be plugged into the second electric socket after having been rotated by 180 degrees.
(2) The unique structural design ensures that when a hard object, such as a nail, is plugged into a single rectangular plugging hole, the object will not be able to make contact with the power line through a plugging hole, therefore no electric shock will happen, so the safety of children is effectively guaranteed; and electric contact with the power lines can only be made if the left-hand plugging hole and the middle plugging hole are plugged into simultaneously, or the right-hand plugging hole and the middle plugging hole are plugged into simultaneously.
(3) In the embodiment, said first sliding part and second sliding part are identical both in structure and in size, and are made from the same mold, thus reducing the production costs.

It is clear that the above embodiment is only an example for illustrating clearly the aspects of the disclosed embodiments, but not a limitation to the implementation thereof. Various changes or alternations can be made on the basis of the above description by one skilled in the art. It is neither necessary nor possible to exhaust all the possible embodiments. Nevertheless, the obvious changes or alternations derived from those belonging to the spirit of the disclosed embodiments are still in the protective scope of the present invention.

What is claimed is:

1. A safety door for a rotatable power supply socket, comprising a mounting base provided with composite plugging holes; a first sliding part, a second sliding part and a third sliding part which are in mutual cooperation; and an elastic assembly arranged on the mounting base; wherein:
said composite plugging holes comprise three rectangular plugging holes arranged at equal distance and in parallel with one another and two ground plugging holes for grounding lines, and said two ground plugging holes are located respectively at the upper side and the lower side of the rectangular plugging holes; the three rectangular plugging holes are respectively referred to in the sequence from left-hand to right-hand as the left-hand plugging hole, the middle plugging hole and the right-hand plugging hole; the two ground plugging holes are respectively referred to in the sequence from top downwards as the upper grounded plugging hole and the lower grounded plugging hole; said left-hand plugging hole, middle plugging hole and upper ground plugging hole constitute a first three-hole power supply socket; said middle plugging hole, right-hand plugging hole and lower ground plugging hole constitute a second three-hole power supply socket;
said mounting base is provided with a rail slot for placing said first sliding part, second sliding part and third sliding part;
said first sliding part can slide reciprocally in said rail slot along the left-right direction, and said first sliding part can block or expose the left-hand plugging hole during its sliding movements;
said second sliding part can slide reciprocally in said rail slot along the left-right direction, and said second sliding part can block or expose the right-hand plugging hole during its sliding movements;
said third sliding part can slide reciprocally in said rail slot along the left-right direction, and said third sliding part can block or expose the middle plugging hole during its sliding movements;
said elastic assembly comprises two main elastic parts for providing returning elastic forces to the third sliding part, a first elastic part for providing a returning elastic force to the first sliding part and a second elastic part for providing a returning elastic force to the second sliding part; and said two main elastic parts are located respectively at two sides of the second sliding part.

2. The safety door for a rotatable power supply socket according to claim 1, wherein the left-hand end of said first sliding part is provided with a block part for blocking the left-hand plugging hole, the right-hand end is provided with a bearing part for bearing external forces; the bottom part of said bearing part is provided with a sliding groove; a limiting hole is provided between said block part and said bearing part; the right-hand end of said bearing part is provided with a slope surface or an arc face as the bearing surface; when unloaded, said bearing part is located just above said middle plugging hole and blocks the lower half of said middle plugging hole, said block part is located just above said left-hand plugging hole and wholly blocks the left-hand plugging hole;
the left-hand end of said second sliding part is provided with a bearing part for bearing external forces, the right-hand end thereof is provided with a block part for blocking the right-hand plugging hole; the bottom part of said bearing part is provided with a sliding groove; a limiting hole is provided between said block part and said bearing part; the left-hand end of said bearing part is provided with a slope surface or an arc face acting as the bearing surface; when unloaded, said bearing part is located just above said middle plugging hole and blocks the upper half of said middle plugging hole, said block part is located just above said right-hand plugging hole and wholly blocks the right-hand plugging hole;
the left-hand end of said third sliding part is provided with a left-hand bearing part for bearing external forces, the right-hand end thereof is provided with a right-hand bearing part for bearing external forces, the middle end is provided with a block part for blocking said middle plugging hole; between said left-hand bearing part and said block part and also between said right-hand bearing part and said block part are each provided with a limiting hole; the left-hand end of said left-hand bearing part is provided with a slope surface or an arc face acting as the bearing surface, and the right-hand end of said right-hand bearing part is provided with a slope surface or an arc face acting as the bearing surface; when unloaded, said block part is located just above said middle plugging hole and in the sliding groove at the bottom part of the bearing part of said first sliding part and the bearing part of said second sliding part, blocking the whole middle plugging hole.

3. The safety door for a rotatable power supply socket according to claim 2, wherein said two main elastic parts are respectively a left-hand main elastic part and a right-hand main elastic part; the left-hand main elastic part is arranged at the left-hand side of the third sliding part, with one end thereof abutting against the mounting base while the other end abuts against the left-hand end of said third sliding part; and the right-hand main elastic part is arranged at the right-hand side of the third sliding part, with one end thereof abutting against the mounting base while the other end abuts against the right-hand end of said third sliding part;
said first sliding part is arranged at the left-hand side of the first sliding part, with one end thereof abutting against the mounting base while the other end abuts against the left-hand end of the first sliding part; and
said second sliding part is arranged at the right-hand side of the second sliding part, with one end thereof abutting against the mounting base while the other end abuts against the right-hand end of the second sliding part.

4. The safety door for a rotatable power supply socket according to claim 3, wherein that said two main elastic parts, the first elastic part and the second elastic part are all leaf springs; said mounting base is provided with a positioning stud assembly for fixing the leaf springs.

5. The safety door for a rotatable power supply socket according to claim 4, wherein said mounting base is provided with a left-hand limiting part for limiting the sliding distance of the first sliding part and a right-hand limiting part for limiting the sliding distance of the second sliding part; said left-hand limiting part is a boss projecting upwards from the right-hand margin of the left-hand plugging hole and is located in the limiting hole of said first sliding part; said right-hand limiting part is a boss projecting upwards from the left-hand margin of the right-hand plugging hole and is located in the limiting hole of said second sliding part.

6. The safety door for a rotatable power supply socket according to claim 5, wherein the left-hand plugging hole can be exposed while the first sliding part is sliding towards the left; and the left-hand plugging hole can be blocked when the first sliding part returns to its original position;
said second sliding part can slide reciprocally in said rail slot along the left-right direction, the right-hand plugging hole can be exposed while the second sliding part is sliding towards the right; and the right-hand plugging hole can be blocked when said second sliding part returns to its original position;
said third sliding part can slide reciprocally in said rail slot along the left-right direction, the middle plugging hole can be exposed while the third sliding part is sliding either towards the left or towards the right; the middle plugging hole is blocked when said third sliding part returns to its original position.

7. The safety door for a rotatable power supply socket according to claim 6, wherein said first sliding part and second sliding part are identical both in structure and in size.

8. The safety door for a rotatable power supply socket according to claim 1, wherein the basic shape of said ground plugging holes is semicircular.
